(19) United States
(12) Patent Application Publication
(10) Pub. No.: US 2024/0005193 A1
(43) Pub. Date: Jan. 4, 2024

(54) PROBABILITY QUANTIZATION MODULATOR/DEMODULATOR AND LASER FOR QUANTUM RADIO

(71) Applicant: Olga Vlasova, Irvine, CA (US)

(72) Inventor: Olga Vlasova, Irvine, CA (US)

(21) Appl. No.: 17/752,850

(22) Filed: May 25, 2022

(51) Int. Cl. G06N 10/40; G06F 7/58

(52) U.S. Cl. CPC G06N 10/40; G06F 7/58

(57) ABSTRACT

The quantum communication principle is based on the phenomenon of synchronized behavior of elementary particles in the case the particles were born entangled. The quantum phenomenon of entanglement is a promising way to implement a link of communication that does not require energy to be sent directly from transmitter to receiver. Instead, a specially designed multi-beam laser can send a constant flow of entangled particles to both transmitter and receiver to tie them via the quantum phenomenon of entanglement. The invention describes the architecture of digital and quantum circuits' combination for quantum radio implementation, which uses modulation of quantum states probabilities in a transmitter and their demodulation in a receiver. In addition, the invention presents the design of a specialized multi-beam laser needed for the implementation of the quantum radio. This invention is a quantum equivalent of the classic electromagnetic radio with an amplitude modulation known as the AM radio.

### BACKGROUND OF THE INVENTION

The Quantum communication principle is based on the phenomenon of synchronized behavior of elementary particles in the case the particles were born entangled. Entanglement of particles means a natural link between them that persists even if a distance separates these particles after birth. Any disturbance to the entangled particles (e.g., measurement of particle's state) causes an instant change of conditions in all related particles. This feature of simultaneous state changes in the entangled collection is essential for secure communication because it physically prevents any eavesdropping. Another unusual property of the entanglement is the possibility that the collective reaction of entangled particles to the changes in any of them appears to spread faster than the speed of light. There is also a paradox of quantum entanglement: the energy needs not to be sent directly from transmitter to receiver to deliver the information. Instead, the fuel may be pumped externally to both transmitter and receiver to supply a constant flow of entangled particles. As an alternative, the power for communication can be preemptively stored in the entangled particles themselves during the process of their creation. The latter communication method of energy stored in the entanglement is a single shot method, and it cannot be used for continuous communication.

The most common approach to transferring information by quantum means is based on a controllable CNOT quantum gate, which combines two qubits (called control and target) states into one dependency. The CNOT quantum gate changes the state of the target qubit to the opposite (|0>->|1>). This method of communication requires a precise determination of quantum states. Thus, it favors low temperatures where the conditions of quantum objects are less affected by thermal oscillations of atoms known as phonons. On the contrary, the invented communication circuit can tolerate room temperature ambient oscillations because it uses averaging of quantum states probability instead of precise determination of the quantum states.

### BRIEF SUMMARY OF THE INVENTION

The invention solves quantum communication tasks currently limited by inaccuracy of determination of quantum states and by fundamental instability of qubits with temperature increase. The design digitally controls and measures qubit states of multiple entangled photons, allowing quantum communication at room temperatures. The target is achieved by probability quantization of orthogonal states |0> and |1>, which can be modulated in a qubit A as a superposition of states. This superposition of orthogonal states can be demodulated in another qubit B entangled with A. The qubits A and B can be separated by a distance which implements a quantum radio. The invention is tolerant of mistakes in measuring quantum states because it averages the quantum states superpositions in numerous qubits.

The invention describes the designs of modulator and demodulator, which represent digital interfaces to the entangled quantum bits. For clarity, the description also includes an example of quantum media, a multi-beam laser, between modulator and demodulator.

### BRIEF DESCRIPTION OF THE SEVERAL VIEWS OF THE DRAWING

FIG. 1 contains a simplified block diagram of the probability modulator, which comprises these main parts: linear feedback shift register 1, disturber 2 for true randomness, probability setting register 3, quantizer (comparator) 4, output register 5, and the modulator's output 6.

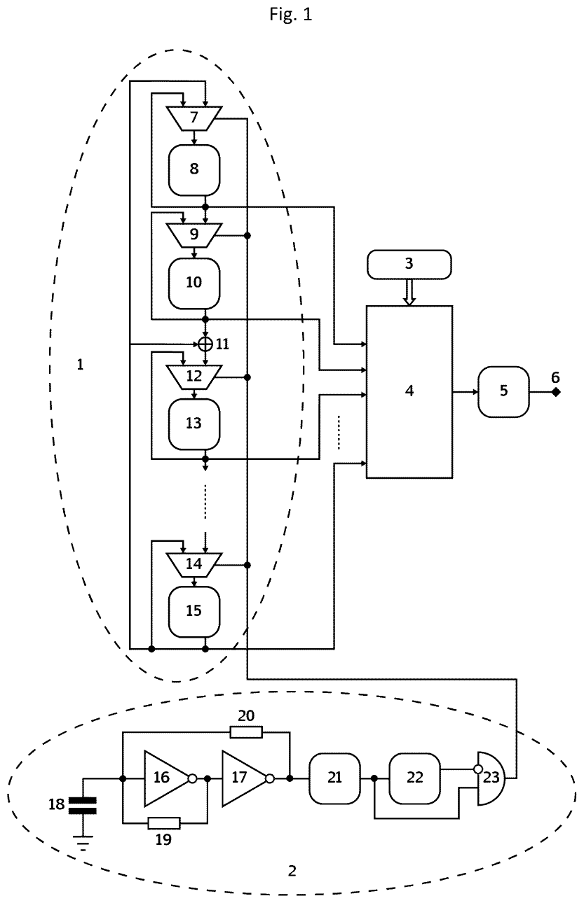

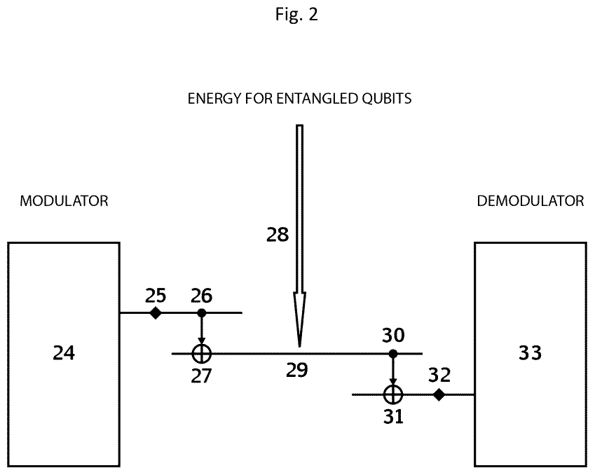

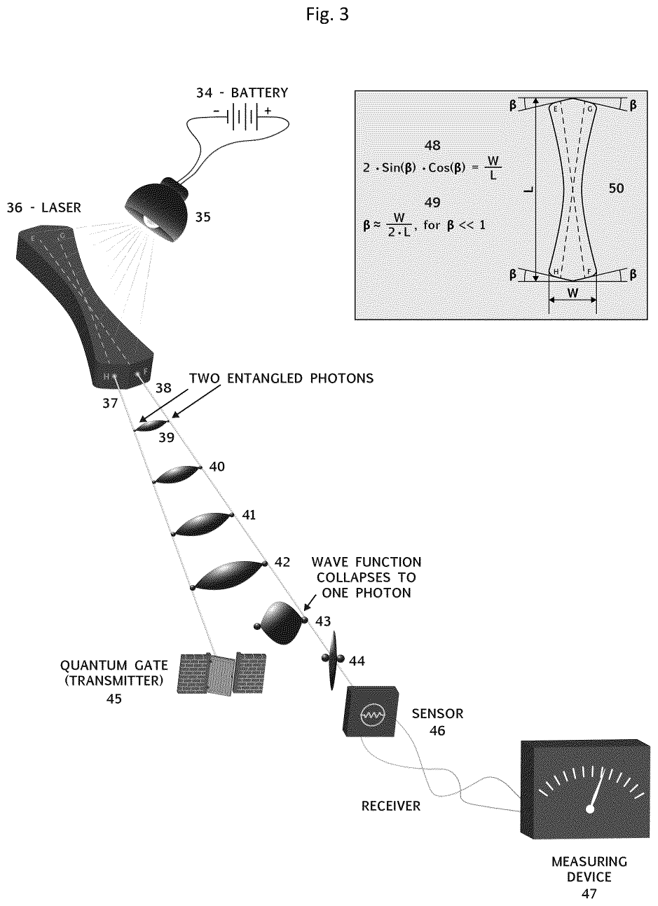

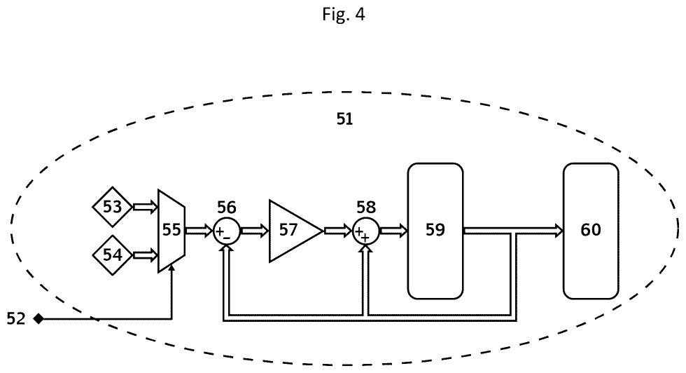

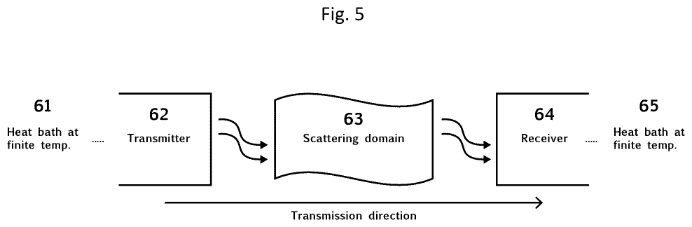

Linear feedback shift register 1 consists of m individual flip-flop bits, where number m is design dependent, typically 16. Only 4 flip-flops out of m bits are shown in FIG. 1, marked as 8, 10, 13, and 15. Linear feedback shift register 1 is a generator of pseudo-random numbers. Feedbacks made via exclusive OR elements (XOR gates) are shown in FIG. 1 as element 11. In addition, a set of m multiplexers 7, 9, 12, and 14 has been added to generate a truly random number.

The multiplexers are controlled by disturber 2 output. Disturber 2 comprises two inverters, 16 and 17, two flip-flops, 21 and 22, and logic AND gate 23. Inventor 16 acts as an RC oscillator whose period of oscillations is determined by capacitor 18 and resistor 19. Inventor 17 and resistor 20 form a Schmitt trigger for better stability of RC oscillator transitions. Flip-flops 21, 22, and logic gate 23 produce a single pulse on the output of gate 23 every time there is a transition from logical 0 to logical 1 on flip-flop 21 output. Gate 23 output pulses go to the multiplexers 7, 9, 12, and 14, which prevent linear feedback register 1 from advancing to the new value for one clock.

The current value of the linear feedback shift register 1 is compared in the quantizer (comparator) 4 with the value stored in the programmable probability setting register 3. The comparison result is a single bit, and it goes to flip-flop 5 and then to output 6 of the modulator.

FIG. 2 describes a general path of the information from the modulator 24 (transmitter) to the demodulator 33 (receiver) via qubits 26, 27, 30, and 31. The signal starts at the modulator's output 25, the same as output 6 from FIG. 1. It goes to the qubit shown as dot 26. This qubit controls another qubit 27 via a controllable quantum CNOT gate depicted as a cross in circle 27. This CNOT operation corresponds to the classic logical exclusive XOR operation. But the difference between the traditional XOR gate and quantum CNOT gate is the reversible behavior of the quantum target qubit. The target qubit state can be changed not only by CNOT gate inputs but also by CNOT gate output if the target qubit is entangled with some other qubit, and that qubit changes its state.

Qubit 27 is entangled with qubit 30. Qubits 27 and 30 are separated by a distance but maintain an entanglement link 29 between them, meaning that any change in the state of qubit 27 causes an instant change in qubit 30. The difference in the states of qubits causes their collapse. Thus, for continuous use, the system requires replenishment of the entangled qubits with an external source of energy 28. The source of energy 28 does not send nor receive the information. It only refreshes the entanglement of qubits 27 and 30.

Qubit 30 is a control bit for the next target quantum bit 31 (CNOT gate 31). This bit 31 drives the input 32 of the demodulator 33 described in FIG. 4 explanation.

FIG. 3 shows a practical implementation of quantum media 29. Quantum media is formed by the couples of entangled qubits 39, 40, 41, 42, 43, 44 issued by an un-modulated laser 36 in two coherent beams, 37 and 38. The laser's gain body 36 is excited by pump light 35, which, in turn, gets energy from battery 34. The beams 37 and 38 are directed toward the transmitter 45 and receiver 46. The laser should be placed so that the entangled photons arrive at the transmitter 45 before they arrive at the receiver 46. The transmitter 45 may collapse (or not) the arriving photons by absorbing them at the gate (obstacle). This absorption at the transmitter's gate 45 affects, in turn, the state of entangled photons arriving at the receiver 46 later on. Thus, sensor 46 of the receiver gets the modulated stream of the photons measured by demodulator 47. FIG. 3 also contains the layout of the multi-beam laser's gain body 50 and the rules to shape its angles for a general case 48 and case 49 when angles between beams are chosen to be small. The related geometry formulas will be discussed in the detailed description of the invention.

FIG. 4 depicts demodulator 51 architecturally designed as an r-bit wide digital integrator. The demodulator 51 has an input 52 (the same as input 32 in FIG. 2), input value multiplexor 55, switching between element 53 (constant value of all zeros) and element 54 (constant value of all ones except two most significant bits, which are zeros), differentiator 56, attenuator 57, adder 58, accumulator 59 and output register 60 which gets an extracted value of qubit 31 (FIG. 2) probability superposition. FIG. 4 also illustrates the feedback from accumulator 59 to the differentiator 56 and adder 58. The integrator's work is discussed in the detailed description of the invention.

FIG. 5 shows the schematic view of the quantum transport problem from a scientific point of view. The interchangeable contacts represent the transmitter 62 and receiver 64. The contacts 62 and 64 are connected to the heat baths 60 and 65, respectively, both at a finite temperature. The transmission direction is assumed to be from left to right. The center part represents the scattering domain 63. In real life, the scattering is influenced by dissipative elements deviating the states of contacts 62 and 64 out of equilibrium. The thermodynamic quantum master equation is discussed in the detailed description of the invention. It can model the time-dependent quantum or classical transmission process between the transmitter 62 and receiver 64.

### DETAILED DESCRIPTION OF THE INVENTION

The invention solves quantum communication limitations plagued by the inaccuracy of determination of quantum states and fundamental instability of qubits at room temperature. The design digitally controls and measures states of multiple qubits to implement quantum communication at room temperatures. The target is achieved by probability quantization of orthogonal states |0> and |1>, which can be modulated in a qubit A as a superposition of states. This superposition of orthogonal states can be demodulated in another qubit B entangled with A. The qubits A and B can be separated by a distance which implements a quantum radio. The invention is tolerant of mistakes in measuring quantum states because it averages the quantum state superposition of multiple coherent particles.

The invention describes the designs of modulator and demodulator, which represent digital interfaces to the entangled quantum bits. For clarity, the description also includes an example of quantum media between modulator and demodulator.

The modulator is depicted in FIG. 1. The modulator works as a random generator of orthogonal states |0> and |1> with a controllable probability of their superposition. Linear feedback shift register 1 produces pseudo-random m-bit numbers for every clock feeding register 1. The value of register 1 is shifted simultaneously in all flip-flops 8, 10, 13, and 15 of register 1. For example, the value of flip-flop 8 goes to flip-flop 10. Simultaneously the value of flip-flop 10 is transferred to the flip-flop 13 and so on until the last flip-flop 15, where it is returned (fed back) to flip-flop 8 and to flip-flop 13 via exclusive XOR gate 11. A complete XOR gate insertion between flops 10 and 13 for feedback is given as an example. The actual width of the shift register and its feedback selection can differ from what is shown. There are underlying LSFR rules (public knowledge) for the shift registers with feedbacks to cover all 2^{m}−1 numbers (except zero value). The line feedback shift register 1 should be initialized to any non-zero value.

To create a random set of numbers, the disturber 2 sends pulses that randomly stop the linear feedback register from advancing. To prevent the shift register from shifting, the multiplexors 7, 9, 12, and 14 are added to the input of each flip-flop. Whenever the disturber 2 generates a pulse, the multiplexors switch inputs of the flip-flops to their respective outputs. Thus, if the disturber's output is logical 1, the line feedback shift register skips its advance for one clock.

The disturber is based on the RC auto-generator implemented on inverter 16. The frequency f of the disturber's oscillation is determined as a reciprocal of the RC product, where R is the resistor 19 value and C is the capacitance of capacitor 18. Therefore, the frequency of the RC oscillator can be calculated as f=1/R·C). The optimal frequency for the RC oscillator of the disturber should be selected as a frequency approximately 4 times slower than the frequency of the clock feeding the flip-flops 21 and 22 of the design. The fact that the RC oscillator is independent of the clock feeding flops while being susceptible to temperature and voltage fluctuations are beneficial for the oscillations' true randomness. Second inverter 17 in the disturber is needed to avoid jittering in the RC oscillator transitions. It provides positive stabilizing feedback on the input of inverter 16 via resistor 20. The value of resistor 20 should be approximately 10 times bigger than the value of resistor 19 in order not to suppress the oscillation itself.

The output of inverter 17 is connected to the flip-flop 21, which is connected to the flip-flop 22. With AND gate 23, the flip-flops 21 and 22 form a circuit that generates a pulse with a duration of 1 clock every time the output of flip-flop 21 has a transition from logical 0 to logical 1. It is achieved by inversion on the top input of AND gate 23. The circuit will also work if flip-flop 21 output transitions from logical 1 to logical 0 are used. In this case, the second input of gate 23 should be inverted instead of the first input of gate 23.

The m-bit random numbers generated by a linear feedback shift register 1 and disturber 2 go to quantizer 4, where they are compared with the m-bit value programmed in the probability setting register 3. If the m-bit random number is greater or equal to the value in register 3, then the output of comparator 4 is set to logical 1; otherwise—to logical 0. This one-bit result of comparison goes to the input of flip-flop 5 and reaches the modulator's output 6. Output 6 toggles randomly, but on average, the probability of logical 1 appearance on output 6 will be proportional to the value stored in register 3 divided by the number 2^{m}. The register 3 value can be changed but no faster than one time per 2^{m} clocks to allow the linear feedback shift register to run through all 2^{m}−1 deals before the update in register 3.

FIG. 2 illustrates the information path from modulator 24 to demodulator 33 via quantum media 29. Quantum media is a couple of entangled qubits 27 and 30. The entanglement is shown as element 29. Qubits 27 and 30 can be placed apart. Still, they stay connected (coherent) because they were born together by the familiar and coherent energy source 28 (which could be a laser or a maser, or a similar device). Due to this entanglement between qubits 27 and 30, the changes in the state of qubit 27 will cause simultaneous and instantaneous changes in qubit 30 states.

On the transmitter's side, qubit 27 is controlled through the CNOT gate by modulator 24 via its output and control qubit 26. Next, the entangled qubit 30 affects the qubit 31 via another CNOT gate on the receiver's side. Then the received information goes to input 32 of the demodulator 33.

FIG. 3 shows a practical implementation of quantum media 29. Quantum media is formed by the constant stream of the entangled couples of qubits 39, 40, 41, 42, 43, 44, which are coherent pairs of photons issued by an un-modulated laser 36 in two coherent beams, 37 and 38. The laser 36 sends no information. It simply creates coherent particles (photons). To emphasize the fact that the laser is unmodulated, the laser's pump source 35 is shown connected to a galvanic battery 34, a steady source of energy.

The coherent beams 37 and 38 with entangled photons are directed toward the transmitter 45 and receiver 46. The transmitter 45 should be placed closer to the laser source of beam 36 than the receiver 46 because events in the transmitter should precede events in the receiver in time. The transmitter 45 may or may not collapse the arriving photons by absorbing them at the gate or passing photons through the transmitter 45. The transmitter 45 absorption affects the state of entangled photons arriving at sensor 46 of the receiver, later on, shown in FIG. 3 as the collapsing entangled photon couples 43 and 44. Sensor 46 provides readings to the measuring device demodulator 47.

Unlike a traditional single-beam laser with two mirrors, the invented laser's gain body 50 is provided with four mirrors, E, F, G, and H, where mirror E is parallel to mirror F, and mirror G is parallel to mirror H. Meanwhile, mirrors E and G are forming angle 180°−2·β. The same angle arrangement is applied to the mirrors F and H. It is important that a gain media between mirrors E and F and a similar gain media between mirrors G and H have a common crossing area in the middle of body 50. It is needed for photons from different beams 37 and 38 to entangle. The width of the laser's middle portion for the entanglement of the beams should be comparable in size to the width of each mirror. This geometric condition dictates the following trigonometric dependency (48) between the width W of the laser's gain body, its length L, and the desired angle between beams 2·β:

$$2 \cdot Sin ( β ) \cdot Cos ( β ) = \frac{W}{L} \qquad ( 48 )$$

For practical purposes and maximization of the entanglement of the laser beams, the half-angle β between two rays should be selected small: β<<1. In this case, equation (48) is simplified into expression (49):

$$β = \frac{W}{2 \cdot L} \qquad ( 49 )$$

FIG. 4 represents the detailed block diagram of demodulator 51. In FIG. 3, the demodulator is depicted as measuring device 47. Together with optical sensor 46, the demodulator 47 forms the receiver. The demodulator 51 is built as a digital integrator consisting of r-bit accumulator 59 and adder 58. The number of bits r in accumulator 59 may be selected the same as m bit of modulator's linear feedback shift register 1 plus some extra bits covering the attenuation coefficient. The input of adder 58 is connected to the output of attenuator 57. Attenuator 57 diminishes the signal amplitude obtained from the differentiator 56 output. The attenuation coefficient determines the integration time. Differentiator 56 subtracts accumulator 59 current values from the incoming values generated by multiplexor 55. Multiplexor 55 switches its output value between constant 53 and constant 54. The control bit of the multiplexor 55 is connected to the single-bit input 52 fed by qubit 31 via output 32. If the value on input 52 is logical 0, the multiplexor 55 selects constant 53 (all zeros 0000 . . . 0, r of them). If the value on input 52 is logical 1, the multiplexor 55 selects constant 54 (0011 . . . 1, number of one's is r−2). The output value of accumulator 59 is latched in the demodulator's output register 60. The value in register 60 follows the value stored in the modulator's register 3. Thus, the radio information reaches its destination.

Connection with the Quantum Transport Equation

One of the essential aspects of quantum communication is obtaining the solution for the quantum transport equation. In quantum mechanics, the evolution of a time-dependent state in Hilbert space is governed by the Schrödinger equation given as

$$\frac{d}{dt} \vert {ψ}_{t} 〉 = - iH \vert {ψ}_{t} 〉 .$$

Here |ψₜ [symbol] is the time-dependent state which is the superposition of the single-qubit states (|ψ [symbol] =α|0 [symbol] +β|1 [symbol] ) and H is the Hamiltonian which is the summation of a free term and a collision term (H=H_{Free}+H_{Coll}). The solution for the Schrödinger equation is the orthonormal set of eigenstates that are evolving at the time upon the initialization. This quantum state solution is a combination of the reversible (relaxed) time-evolution represented by the free term (H_{Free}) and the irreversible (dissipative) process described by the collision term (H_{Coll}). Theoretically, the presence of the irreversible term is the reason for developing a low-temperature qubit (as a computational unit that mimics the solution for quantum states).

However, in the current invention, we proposed the modulator/demodulator qubit model that works at a finite temperature. Therefore, we use an alternate view to describe the quantum system based on non-equilibrium thermodynamics and the image of the physics of particles. In this view, quantum transport is seen as a quantized system connected to a heat bath with a finite temperature. The thermodynamics quantum master equation describes the dynamics of such a system as

$$\frac{d {ρ}_{t}}{dt} = - i [ H , ρ ] + {\sum }_{ω} h ( ω ) ( {A}_{ω} ρ {A}_{ω}^{†} - \frac{1}{2} \{ {A}_{ω}^{†} {A}_{ω} , ρ \} ) ,$$

where the ρₜ is the time-dependent density matrix defined as the number of states occurring at specific probability ρₜ=|ωₜ [symbol] [symbol] ψₜ| and A is time-independent defined as the average of observables. The first term on the right-hand side represents the reversible term similar to the Schrödinger picture, and the second term describes the time-independent irreversible term. Physical understanding of the quantum master equation denotes the non-equilibrium quantum transport between a transmitter and a receiver (connected to a heat bath at finite temperature) and a scattering process that dissipates the transport process. We argue that our finite temperature qubit system resembles the same characteristics as the thermodynamics quantum master equation.

The modulator and demodulator serve as a transmitter and receiver, respectively, and the random distributor is the source of scattering. Thus, the proposed innovation can be a real-life quantum solver for the thermodynamic quantum master equation.

The quantum master equation describes the non-equilibrium quantum transport between a transmitter and a receiver (connected to a heat bath at finite temperature) and a scattering process that dissipates the transport process. The schematic view of the quantum transport is shown in FIG. 5. The figure shows that the quantum transport between transmitter 62 and receiver 64 connected to the heat baths 61 and 65, respectively, can be identified as two entangled entities. Meanwhile, the scattering process 63 disturbs the entangled entities from equilibrium. This results in non-equilibrium quantum transport between the transmitter and receiver. In the stochastic approach, the non-equilibrium condition is created by adding or removing arbitrary random elements to dissipate the entangled states from the equilibrium condition.

The current invention is a facilitator to solve problems in quantum field theory, particularly when the stochastic approach is used. This invention includes:
measurements of entangled states between interchangeable transmitter and receiver connected to heat baths at finite temperature;
ability to measure the time-dependent scattering process of the noisy system;
superposition and scalability of both entangled states.

The digital aspect of the current invention is advantageous in manufacturing a qubit device that can construct an entangled superposition state of many qubits. Thus, the proposed innovation can be a stochastically driven solver for the thermodynamic quantum master equation. The current invention and the thermodynamic quantum master equation are general quantum solvers that apply to fermions, bosons, phonons, and information.

The substitute specification contains no new matter.

We claim:

1. A modulator (transmitter) circuit for the generation of a sequence of random bits with the ability to change the probability of a superposition of two orthogonal states |0> and |1> comprising:
a. a linear shift m-bit register generating 2^{m}−1 numbers;
b. a random disturber stopping the linear shift register from advancing at a rate slower than the linear shift register clock;
c. an m-bit register for storing a value of the desired probability of the orthogonal states; and
d. a quantizer (arithmetical comparator between the value of the linear shift register and the value stored in the programmable m-bit register) for driving the output of the gate with the orthogonal states |0> and |1> proportionally to the programmed probability but randomly.

2. A multi-beam laser with a common for the beams optical gain media for generation of at least two coherent beams for sending entangled photons to the transmitter and the receiver or the multiple transmitters and receivers;
a. a “butterfly bow tie” shaped laser's optical gain media for the generation of two coherent light beams exiting the laser's body at an angle to each other to illuminate both the transmitter and the receiver with entangled photons;
b. a spatial combination of numerous “butterfly bow ties” shaped laser's optical gain bodies for the generation of three or more coherent light beams exiting the combined laser's bodies at angles to each other to illuminate multiple transmitters and receivers with entangled photons.

3. A demodulator (receiver) circuit for determination of the probability value of a superposition of two orthogonal states |0> and |1> in the entangled qubits comprising:
a. an integrator with r bits accumulator and differentiator on accumulator's input;
b. an r-bit output register that holds the extracted value of the probability of superposition of the entangled qubit orthogonal states |0> and |1>.
